(19) United States
(12) Patent Application Publication
(10) Pub. No.: US 2008/0208913 A1
(43) Pub. Date: Aug. 28, 2008

(54) METHOD AND APPARATUS FOR ONE CLICK FORWARDING OF DENTAL IMAGES TO OR FOR THE BENEFIT OF A REFERRING SOURCE

(76) Inventor: Marc S. Lemchen, New York, NY (US)

Correspondence Address: MYERS DAWES ANDRAS & SHERMAN, LLP, 19900 MACARTHUR BLVD., SUITE 1150, IRVINE, CA, 92612, US

(21) Appl. No.: 12/035,675

(22) Filed: Feb. 22, 2008

Related U.S. Application Data
(60) Provisional application No. 60/891,486, filed on Feb. 23, 2007.

(51) Int. Cl. G06F 17/30

(52) U.S. Cl. 707/104.1; 707/E17.019

(57) ABSTRACT

The invention is an apparatus, recorded computer program, and a method for use in dentistry, orthodontics, or medical/dental fields, which method includes the steps of designating a referring source for a data image or scan, making the data image or scan, storing the data image or scan in a file corresponding to a patient, and automatically uploading the stored file to a predetermined remote computer site accessible to the referring source.

### RELATED APPLICATIONS

The present application is related to U.S. Provisional Patent Application, Ser. No. 60/891,486, filed on Feb. 23, 2007, which is incorporated herein by reference and to which priority is claimed pursuant to 35 USC 119.

### BACKGROUND OF THE INVENTION

1. Field of the Invention

The invention relates to the field of data systems and data methods used in the field of dental medicine.

2. Description of the Prior Art

In the prior art practice when the dental assistant or any staff member takes, for an example, an x-ray, it is put in the patient's digital file. The file may be part of a proprietary software program (such as Dolphin Imaging Systems) or part of the operating system (Windows, Vista, etc.) Currently a dental practitioner must click on an email address, pick the desired recipient and approve the sending of the image to a secure site, making it available to a selected person, often to the referring dentist, insurance provider or patient. To get to the secure site or recipient, the assistant must upload or “file” the image first, then indicate that he or she would like it sent to the referring doctor/patient or recipient address. Then the dental assistant must upload this file to a secure site or e-mail it to the referral.

### BRIEF SUMMARY OF THE INVENTION

The illustrated embodiment of the invention is a method for use in dentistry, orthodontics, or medical/dental fields. Digital images, such as x-rays and photos, are taken and usually cropped and captured into a digital file for the patient. The images are uploaded to a predetermined local or onsite storage site, such as the patient's Dolphin File™, then from the Dolphin File™ the images either are emailed or preferably upload it to a secure web site, often a third party site, and a separate communication sent to the doctor/patient or recipient site with an email note to click on a link in the email to be taken to the web site to view, and if permission is granted, download the full image.

Even before the image is taken it can be designated to send the x-ray or photo image automatically to the referring doctor and or patient upon loading the initial data into the patient's digital file, thereby eliminating the time consuming steps of again designating the fact that 1) the image should be sent to an individual and 2) to whom it should be sent. The images are automatically sent to the referring doctor, patient, or other designated parties when first downloaded into the patient's digital file.

More particularly, the illustrated embodiment of the invention includes a method for use in dentistry, orthodontics, or medical/dental fields comprising the steps of: designating a referring source for a data image or scan; making the data image or scan; storing the data image or scan in a file corresponding to a patient; and automatically uploading the stored file to a predetermined remote computer site accessible to the referring source.

The step of automatically uploading the stored file to either a predetermined remote computer site accessible to the referring source comprises the step of automatically uploading the stored file to a computer site of the referring source for the patient.

The step of automatically uploading the stored file to either a predetermined remote computer site accessible to the referring source comprises the steps of automatically uploading the stored file to a third party website, automatically sending a notice to the referring source from an originating site and enabling access to the referring source to the third party website.

The method further comprises the step of automatically generating a receipt of the notice and automatically sending the receipt to the originating site.

The method further comprises the step of automatically storing the receipt in the file corresponding to the patient, the receipt including historical communication data and identity of the referring source.

The method further comprises the step of processing the image or scan before storing the data image or scan in a file corresponding to a patient.

The method further comprises the step of cropping and/or reconstructing the image or scan before storing the data image or scan in a file corresponding to a patient.

The method further comprises the step of cropping and/or reconstructing the image or scan before storing the data image or scan in a file corresponding to a patient.

The step of automatically uploading the stored file to either a predetermined remote computer site accessible to the referring source comprises the step of uploading the stored filed with an appended message having a greeting, explanation, patient or data identification or other information to the referring source.

The method further comprises the steps of requesting verification of receipt of the stored file from the receiving remote computer site to verify that the stored file was received; tracking stored files sent which did not receive verification back from the remote computer site; and automatically recommunicating with the remote computer site after a predetermined time period to re-request verification of receipt of the stored file from the receiving remote computer site.

The step of automatically uploading the stored file to either a predetermined remote computer site accessible to the referring source further comprises the step of automatically uploading the stored file to either a predetermined remote computer site accessible to the referring source for all images or scans subsequently made relating to the patient.

The step of automatically uploading the stored file to either a predetermined remote computer site accessible to the referring source for all images or scans subsequently made relating to the patient further comprises contingently cancelling the automatic uploading the stored file upon a user input.

The illustrated embodiment also includes an apparatus for performing each of the above steps. The apparatus may be implemented in many equivalent ways including in particular in a computer network, such as user computer coupled via the internet to a computer of the referring source and to a third party website server interconnected to both the user computer and the computer of the referring source. The means for performing the steps of the various embodiments of the method include software programs stored in various computers in the computer network, which software programs arrange and configure the computer network and its components to cooperatively perform the claimed steps.

The illustrated embodiment also includes a computer readable storage medium on which is stored a set of instructions for controlling a computer or computer network to allow a user to perform the steps of the above method or to control the above apparatus.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a flow diagram of the prior art method of handling medical or dental data files in a referral communication.

FIG. 2 is a flow diagram illustrating how medical or dental files are process according to the illustrated embodiment of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

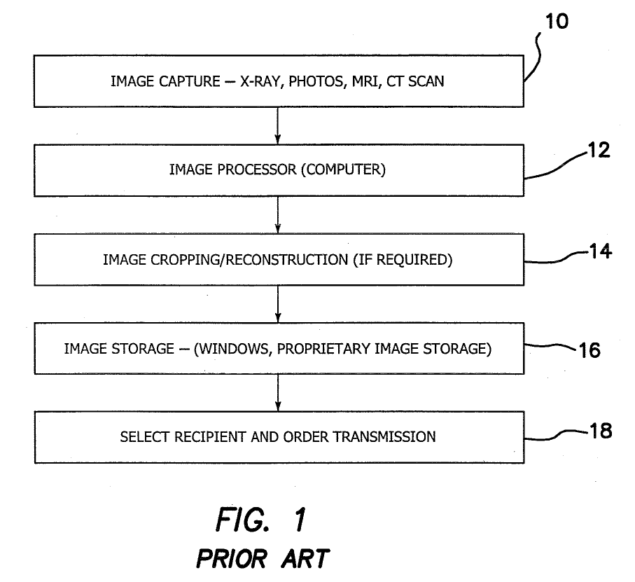

FIG. 1 illustrates the prior art methodology of handling dental and data information in the context of referral communications of the same. The process begins at step 10 with the image capture of the data, typically an x-ray, facial photograph, MRI, CT scan or other tomographic data collection of a selected portion of a patient's teeth, jaw or anatomy. The data is then manually uploaded at step 12 into a computer in which the image is processed to form an image, which may be an artificially enhance image wherein certain characteristics of the data are emphasized or deemphasized to show the desired feature or aspect.

Once the data is filtered, computed, rendered or the desired image quality is obtained, the resulting processed data may be manually edited at step 14, which typically contemplates cropping the image or reconstructing a desired view based on the newly acquired data such as may be used in oral surgical procedures. Image reconstruction includes any processing of raw data, such as in a CAT or CBCT scan are data slices, and reconstructing a selected view from the data set, such as panoramic, cehphalometric (lateral or PA), and the like of any particular area, slice, cross section or anatomical aspect.

The edited image is then manually stored at step 16 in a data bank such as some type of Windows formatted filing system or in a proprietary image storage system where it is combined or related to other dental or personal information on the patient.

Finally, the stored image is manually selected and addressed at step 18 in an email program or other communications application program for transmission to a third party website or email address with the manual creation of a message to the recipient to open the attached file or to follow an included internet link to a website where the file can be accessed using certain specially provided access codes and downloaded.

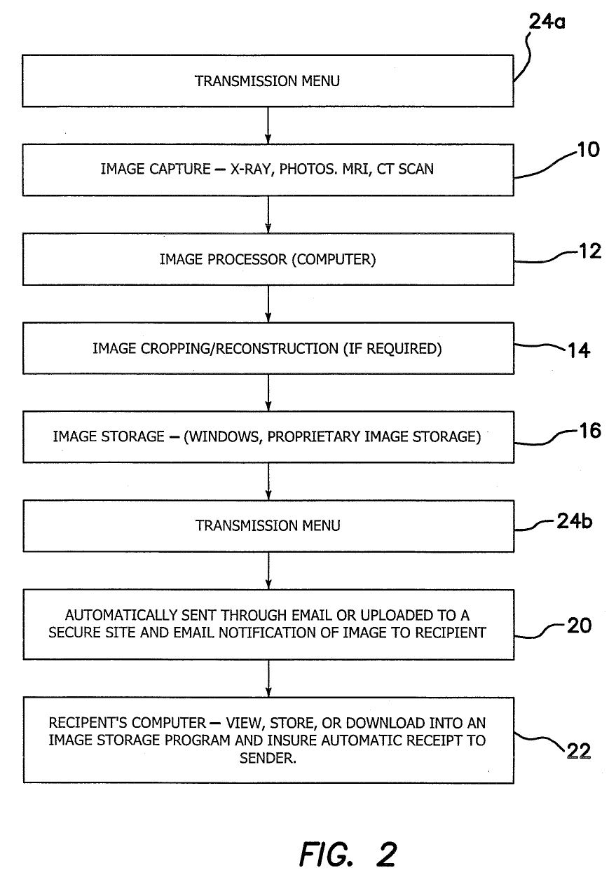

The illustrated embodiment uses a software program to automatically upload the locally stored image files to a separate web site and/or e-mail the images, either before or limited to post cropping and data filing, to a referring professional and or patient/parent/responsible party as illustrated in FIG. 2. Again the conventional process is followed with respect to steps 10-16 until a final, processed and possibly edited image file of data has been prepared at step 16. However, when the data file is stored at step 16, the illustrated embodiment automatically uploads the prepared image to the designated address or third party website as prestored and selected through a transmission menu at step 24a or 24b. Step 24a is shown occurring prior to data capture step 10 or as an intermediate step 24b between image storage step 16 and automatic sending step 20. The transmission menu may be performed at any time a according to user preference and convenience. In the transmission menu 24a or 24b the user chooses from a recipient list or inserts a recipient if not already included on a listing. The time of transmittal to the recipient may also be designated from an menu listing or choices, such as with each new image as it is obtained at any one of the steps 10-16, to send an image only if the image is selected after any one of the steps 10-16, or to send the selected image only on demand from the recipient or other source. Once a transmittal mode for a recipient is selected, it can be used as a default mode without the need for reselection at a later time.

Whatever the transmittal mode may be, at step 20 the transmission is made automatically according to the prior choices either through email, fax or uploaded to a secure website with automatic generation of a communication to the recipient that it is available there for later download.

When the data file is viewed, stored or downloaded at the recipient's computer into an image storage program, an automatic receipt is generated with the appropriate indication showing which action was taken, when and by whom and automatically sent at step 22 to the original sender of the data, whose address is embedded in the transmission file downloaded or opened by the recipient. The receipt is automatically filed at step 22 in the patient's digital file related to the sent data so that the history of the communication of the dental or medical data is of record.

Thus the program of the illustrated embodiment by default automatically uploads the image to the referring dentist and or patient/parent/responsible party, with or without a note having a standard greeting, explanation, identification or other routine dental information.

This way every time an x-ray, or other type of image, is taken, that patient's dentist automatically gets access to that image, and notification of the availability of the image, either thru our secure web site, such as Anywhere Dolphin™ or emailed to his/her direct email address.

The receiving referral is optionally asked to verify that the communication was received; thereby keeping track of records sent which did not receive notification back for an automatic follow up. This verification can be automatically placed in the patient's chart.

In one embodiment the initial designation of the recipient of all images or scans taken for a given patient is stored in the patient file with the result that the same recipient is “automatically” sent all subsequent images or scans stored for that same patient without any further intervention of the user. A selection or user input only would need to be made in those cases where the particular images or scans were not to be sent. Cancellation of such a default automatic file transfer can be made as an optional input in the patient record or file that subsequent images or scans will be automatically sent unless stopped by clicking a check box in a pop-up screen.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method for use in dentistry, orthodontics, or medical/dental fields comprising the steps of:
designating a referring source for a data image or scan;
making the data image or scan;
storing the data image or scan in a file corresponding to a patient; and
automatically uploading the stored file to a predetermined remote computer site accessible to the referring source.

2. The method of claim 1 where automatically uploading the stored file to either a predetermined remote computer site accessible to the referring source comprises automatically uploading the stored file to a computer site of the referring source for the patient.

3. The method of claim 1 where automatically uploading the stored file to either a predetermined remote computer site accessible to the referring source comprises automatically uploading the stored file to a third party website, automatically sending a notice to the referring source from an originating site and enabling access to the referring source to the third party website.

4. The method of claim 1 where automatically uploading the stored file to either a predetermined remote computer site accessible to the referring source further comprises automatically uploading the stored file to either a predetermined remote computer site accessible to the referring source for all images or scans subsequently made relating to the patient.

5. The method of claim 4 where automatically uploading the stored file to either a predetermined remote computer site accessible to the referring source for all images or scans subsequently made relating to the patient further comprises contingently cancelling the automatic uploading the stored file upon a user input.

6. The method of claim 3 further comprising automatically generating a receipt of the notice and automatically sending the receipt to the originating site.

7. The method of claim 6 further comprising automatically storing the receipt in the file corresponding to the patient, the receipt including historical communication data and identity of the referring source.

8. The method of claim 1 further comprising processing the image or scan before storing the data image or scan in a file corresponding to a patient.

9. The method of claim 1 further comprising cropping and/or reconstructing the image or scan before storing the data image or scan in a file corresponding to a patient.

10. The method of claim 8 further comprising cropping and/or reconstructing the image or scan before storing the data image or scan in a file corresponding to a patient.

11. The method of claim 1 where automatically uploading the stored file to either a predetermined remote computer site accessible to the referring source comprises uploading the stored filed with an appended message having a greeting, explanation, patient or data identification or other information to the referring source.

12. The method of claim 1 further comprising requesting verification of receipt of the stored file from the receiving remote computer site to verify that the stored file was received; tracking stored files sent which did not receive verification back from the remote computer site; and automatically recommunicating with the remote computer site after a predetermined time period to re-request verification of receipt of the stored file from the receiving remote computer site.

13. An apparatus for use in dentistry, orthodontics, or medical/dental fields comprising:
means for designating a referring source for a data image or scan;
means for making the data image or scan;
means for storing the data image or scan in a file corresponding to a patient; and
means for automatically uploading the stored file to a predetermined remote computer site accessible to the referring source.

14. The apparatus of claim 13 where the means for automatically uploading the stored file to either a predetermined remote computer site accessible to the referring source comprises means for automatically uploading the stored file to a computer site of the referring source for the patient.

15. The apparatus of claim 13 where the means for automatically uploading the stored file to either a predetermined remote computer site accessible to the referring source comprises means for automatically uploading the stored file to a third party website, means for automatically sending a notice to the referring source from an originating site and means for enabling access to the referring source to the third party website.

16. The apparatus of claim 15 further comprising means for automatically generating a receipt of the notice and means for automatically sending the receipt to the originating site.

17. The apparatus of claim 16 further means for comprising automatically storing the receipt in the file corresponding to the patient, the receipt including historical communication data and identity of the referring source.

18. The apparatus of claim 13 where the means for automatically uploading the stored file to either a predetermined remote computer site accessible to the referring source further comprises means for automatically uploading the stored file to either a predetermined remote computer site accessible to the referring source for all images or scans subsequently made relating to the patient.

19. The apparatus of claim 18 where the means for automatically uploading the stored file to either a predetermined remote computer site accessible to the referring source for all images or scans subsequently made relating to the patient further comprises means for contingently cancelling the automatic uploading the stored file upon a user input.

20. The apparatus of claim 13 further comprising means for processing the image or scan before storing the data image or scan in a file corresponding to a patient.

21. The apparatus of claim 13 further comprising means for cropping and/or reconstructing the image or scan before storing the data image or scan in a file corresponding to a patient.

22. The apparatus of claim 18 further comprising means for cropping and/or reconstructing the image or scan before storing the data image or scan in a file corresponding to a patient.

23. The apparatus of claim 13 where the means for automatically uploading the stored file to either a predetermined remote computer site accessible to the referring source comprises means for uploading the stored filed with an appended message having a greeting, explanation, patient or data identification or other information to the referring source.

24. The apparatus of claim 13 further means for comprising requesting verification of receipt of the stored file from the receiving remote computer site to verify that the stored file was received; means for tracking stored files sent which did not receive verification back from the remote computer site; and means for automatically recommunicating with the remote computer site after a predetermined time period to re-request verification of receipt of the stored file from the receiving remote computer site.

25. A computer readable storage medium on which is stored a set of instructions for controlling a computer or computer network to allow a user to perform the steps of the method of claim 1.
